(19) United States
(12) Patent Application Publication
(10) Pub. No.: US 2025/0112337 A1
(43) Pub. Date: Apr. 3, 2025

(54) BATTERY MODULE, BATTERY PACK AND VEHICLE

(71) Applicant: FORD GLOBAL TECHNOLOGIES, LLC, Dearborn, MI (US)

(72) Inventors: Peng Fei HE, Nanjing (CN); Rui FENG, Nanjing (CN); Fei GAO, Hefei (CN); Larry WANG, Nanjing (CN)

(21) Appl. No.: 18/820,799

(22) Filed: Aug. 30, 2024

(30) Foreign Application Priority Data
Sep. 28, 2023 (CN) 2023112823579

(51) Int. Cl. H01M 50/51; H01M 10/613; H01M 10/625; H01M 10/6551; H01M 50/209; H01M 50/358; H01M 50/507; H01M 50/519

(52) U.S. Cl. CPC H01M 50/51; H01M 10/613; H01M 10/625; H01M 10/6551; H01M 50/209; H01M 50/358; H01M 50/507; H01M 50/519; H01M 2220/20

(57) ABSTRACT

The present disclosure provides a battery module, battery pack and vehicle. The battery module comprises: two battery blocks opposite each other, each of the battery blocks comprising a plurality of battery cells arranged along a first direction; and a circuit board disposed between the two battery blocks, the circuit board comprising a substrate and a plurality of electrical connectors passing through the substrate and arranged along the first direction, and the plurality of electrical connectors alternately connecting the plurality of battery cells of the two battery blocks in series; wherein each of the battery cells of one battery block is staggered and opposite to a corresponding battery cell of the other battery block, a tail-end electrode of a battery cell of the one battery block is aligned with a head-end electrode of a battery cell of the other battery block, and the tail-end electrode is connected to the head-end electrode by the electrical connector. The technical solution of the present disclosure can reduce the use of circuit boards and/or busbars, thereby the construction of the battery pack can be simplified, the manufacturing efficiency can be improved, and the production costs can be reduced.

### CROSS-REFERENCE TO RELATED APPLICATIONS

This application claims priority to Chinese Patent Application No. 2023112823579, filed Sep. 28, 2023, which is incorporated by reference herein in its entirety.

### TECHNICAL FIELD

This disclosure relates generally to the field of vehicles and, more particularly, to a battery module, battery pack, and vehicle.

### BACKGROUND

With the development of the vehicle industry, new energy vehicles, including but not limited to battery electric vehicles (BEVs), hybrid electric vehicles (HEVs), and plug-in hybrid electric vehicles (PHEVs), have become increasingly popular. The new energy vehicles are powered by battery packs.

In some known electric vehicles, the vehicle battery pack can include multiple battery modules arranged within a battery pack housing and electrically connected to each other through wires. Each battery module includes multiple battery cells stacked and electrically connected to each other through circuit boards and/or busbars. In order to provide sufficient power, the battery packs use a large number of battery cells, which correspondingly require a large number of circuit boards and/or busbars. These arrangements can pose production and manufacturing challenges.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of this application recognize that there is a need for an improved battery pack that can reduce the use of circuit boards and/or busbars without reducing battery capacity, and thereby the construction of the battery pack can be simplified, the manufacturing efficiency can be improved, and the production costs can be reduced.

According to an aspect of the present disclosure, a battery module is provided, comprising:
two battery blocks opposite each other, each of the battery blocks comprising a plurality of battery cells arranged along a first direction; and
a circuit board disposed between the two battery blocks, the circuit board comprising a substrate and a plurality of electrical connectors passing through the substrate and arranged along the first direction, and the plurality of electrical connectors alternately connecting the plurality of battery cells of the two battery blocks in series;
wherein each of the battery cells of one battery block is staggered and opposite to a corresponding battery cell of the other battery block, a tail-end electrode of a battery cell of the one battery block is aligned with a head-end electrode of a battery cell of the other battery block, and the tail-end electrode is connected to the head-end electrode by the electrical connector.

According to an embodiment of the present disclosure, the electrical connector is a connecting sleeve, and the head-end electrode and the tail-end electrode are inserted into the connecting sleeve from two ends, respectively.

According to an embodiment of the present disclosure, the head-end electrode and the tail-end electrode of each battery cell are spaced by a distance of half of a dimension of the battery cell along the first direction, and the battery cell of the one battery block is staggered by a distance of half of the dimension of the battery cell along the first direction relative to the corresponding battery cell of the other battery block.

According to an embodiment of the present disclosure, the battery cells are placed flat.

According to an embodiment of the present disclosure, each of the battery blocks comprises two layers of battery cells stacked along a second direction, each layer of the battery cells comprises multiple battery cells;

the circuit board has two rows of electrical connectors arranged along the second direction, each row of the electrical connectors comprising multiple electrical connectors;

the battery cells located in a first layer of the two battery blocks are alternately connected in series through a first row of electrical connectors to form a first current path;

the battery cells located in a second layer of the two battery blocks are alternately connected in series through a second row of electrical connectors to form a second current path; and

the circuit board is further provided with a busbar that connects the first current path and the second current path in series.

According to an embodiment of the present disclosure, the battery module has a first end and a second end in the first direction, the first current path has a flow direction from the first end to the second end, the second current path has a flow direction from the second end to the first end, and the busbar connects the first current path and the second current path at the second end.

According to an embodiment of the present disclosure, the busbar has a length equal to the distance between the two rows of electrical connectors in the second direction.

According to an embodiment of the present disclosure, each of the battery blocks comprises a U-shaped housing containing the multiple battery cells, and both of the U-shaped housings of the two battery blocks have an opening opposite each other.

According to an embodiment of the present disclosure, the U-shaped housing has a hollow structure.

According to an embodiment of the present disclosure, the U-shaped housings of the two battery blocks are aligned at end, one end of the U-shaped housing has a void portion, and the battery module further comprises a battery control module disposed in the void portion and electrically connected to the circuit board.

According to an embodiment of the present disclosure, each of the battery blocks further comprises multiple heat conduction channels arranged along the first direction, and each of the heat conduction channels extends along the second direction and communicates with a ventilation portion of two battery cells stacked.

According to another aspect of the present disclosure, a battery module is provided, comprising:
two battery blocks opposite each other, each of the battery blocks comprising two layers of battery cells stacked along a first direction, each layer of the battery cells comprising multiple battery cells arranged along a second direction; and
a circuit board disposed between the two battery blocks, the circuit board comprising:
   a substrate;
   two rows of electrical connectors passing through the substrate and arranged along the first direction, and each row of the electrical connectors comprising a plurality of electrical connectors arranged along the second direction; and
   a busbar connecting the same ends of the two rows of the electrical connectors;
wherein a first row of the electrical connectors alternately connects the battery cells of a first layer of the two battery blocks in series, a second row of the electrical connectors alternately connects the battery cells of a second layer of the two battery blocks in series; the battery cells in same layer of the two battery blocks have same electrode arrangement sequence, and the battery cells in different layers of the same battery block have opposite electrode arrangement sequence.

According to an embodiment of the present disclosure, each of the battery cells of one battery block is staggered and opposite to a corresponding battery cell in the same layer of the other battery block, a tail-end electrode of a battery cell of the one battery block is aligned with a head-end electrode of a battery cell of the other battery block, and the tail-end electrode is connected to the head-end electrode by the electrical connector.

According to an embodiment of the present disclosure, the electrical connector is a connecting sleeve, and the head-end electrode and the tail-end electrode are inserted into the connecting sleeve from two ends, respectively.

According to an embodiment of the present disclosure, the head-end electrode and the tail-end electrode of each battery cell are spaced by a distance of half of a dimension along the second direction of the battery cell, and the battery cell of the one battery block is staggered by a distance of half of a dimension along the second direction of the battery cell relative to the corresponding battery cell of the other battery block.

According to an embodiment of the present disclosure, the battery cells are placed flat.

According to an embodiment of the present disclosure, each of the battery blocks comprises a U-shaped housing containing the multiple battery cells, both of the U-shaped housings of the two battery blocks have an opening opposite each other, the U-shaped housings of the two battery blocks are aligned at end, one end of the U-shaped housing has a void portion, and the battery module further comprises a battery control module disposed in the void portion and electrically connected to the circuit board.

According to an embodiment of the present disclosure, each of the battery blocks further comprises multiple heat conduction channels arranged along the second direction, and each of the heat conduction channels extends along the first direction and communicates with a ventilation portion of two battery cells stacked.

According to a further aspect of the present disclosure, a battery pack is provided, comprising:
a battery pack housing; and
one or more battery modules as described in any one of the above embodiments disposed within the battery pack housing.

According to yet another aspect of the present disclosure, a vehicle is provided, comprising the battery pack as described in the above embodiments.

### BRIEF DESCRIPTION OF THE FIGURES

In order to better understand the present disclosure, reference can be made to the embodiments shown in the following drawings. The components in the drawings may not necessarily be drawn to scale, and relevant components may be omitted, or in some cases, the scale may have been enlarged to emphasize and clearly illustrate the novel features described in this disclosure. Additionally, as known in the art, system components can be arranged differently. Further in the figures, like reference numbers refer to like parts throughout the different figures.

FIG. 1 illustrates an overall schematic diagram of a battery module according to an embodiment of the present disclosure.

FIG. 2 illustrates a schematic diagram of a staggered arrangement of battery cells in two battery blocks according to an embodiment of the present disclosure.

FIG. 3 illustrates a schematic diagram of an arrangement of two battery blocks and a circuit board according to an embodiment of the present disclosure.

FIG. 4 illustrates a schematic diagram of a current path of the battery module according to an embodiment of the present disclosure.

FIG. 5 illustrates a partial schematic diagram of a first end of the battery module according to an embodiment of the present disclosure.

FIG. 6 illustrates a partial schematic diagram of a second end of the battery module according to an embodiment of the present disclosure.

FIG. 7 illustrates another partial schematic diagram of the second end of the battery module according to an embodiment of the present disclosure.

FIG. 8 illustrates a schematic diagram of adjusting a length of the battery module according to an embodiment of the present disclosure.

FIG. 9 illustrates a schematic diagram of battery cells of the two battery blocks according to an embodiment of the present disclosure.

FIG. 10 illustrates a schematic diagram of a heat conduction channel of the battery module according to an embodiment of the present disclosure.

FIG. 11 illustrates a schematic diagram of a battery pack according to an embodiment of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this application document, when an element or part is referred to as being “on”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on”, “directly bonded to”, “directly connected to”, or “directly coupled to” another element or part, the intervening elements or parts may not be present. Other words used to describe the relationship between elements should be interpreted in a like fashion.

The vehicle involved in the following embodiments can be a standard gasoline-powered vehicle, a hybrid electric vehicle (HEV), a battery electric vehicle (BEV), a plug-in hybrid electric vehicle (PHEV), a full hybrid electric vehicle (FHEV), a fuel cell vehicle, and/or any other types of vehicle, such as buses, watercraft, or aircraft. The vehicle can include components related to mobility such as an engine, electric motor, transmission, suspensions, drive axles, and/or wheels. The vehicle can be non-autonomous, semi-autonomous (for example, some routine motion functions are controlled by the vehicle), or autonomous (for example, motion functions are controlled by the vehicle without direct input from a human driver).

As mentioned in the background, prior art vehicle battery pack designs require the use of a large number of circuit boards and/or busbars. The busbars may be integrated into the circuit board or exist independently. In order to achieve specific connection modes between different battery cells, a large number of busbars may be complexly arranged. In addition, the battery pack may also be equipped with related battery state detection modules, which require a large number of sampling lines when detecting the states of numerous battery modules. The use of a large number of circuit boards, busbars, sampling lines, and/or other related electrical connection components leads to a complex battery pack structure, time-consuming manufacturing, and high costs. As described in further detail below, in one or more embodiments, a battery module, a battery pack, and a vehicle are provided to overcome the challenges in the prior art.

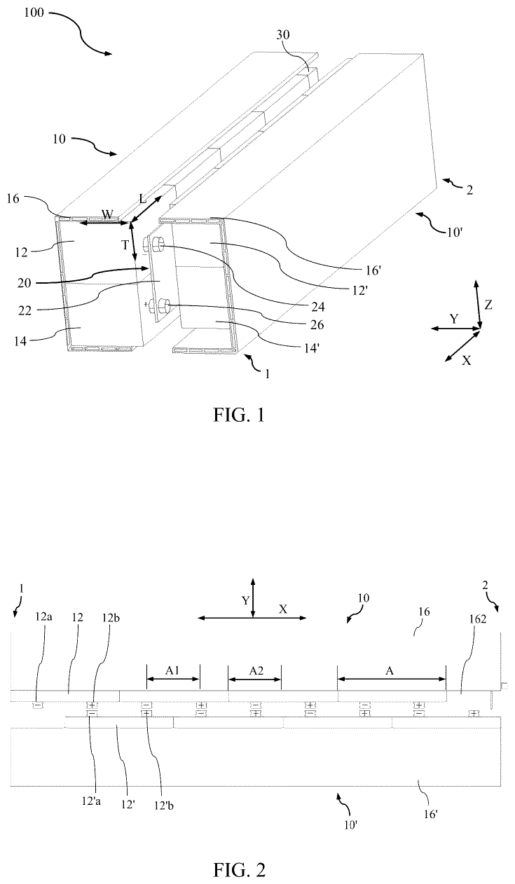

Referring to FIGS. 1 to 4, the present disclosure provides a battery module 100 including battery blocks 10, 10′ opposite each other, and a circuit board 20 disposed between the battery blocks 10, 10′. The battery block 10 includes at least one plurality of battery cells 12, 14 arranged along the X direction. Similarly, the battery block 10′ includes at least one plurality of battery cells 12′, 14′ arranged along the X direction. The circuit board 20 includes a substrate 22 and at least one plurality of electrical connectors 24, 26 passing through the substrate 22 and arranged along the X direction. The plurality of battery cells 12, 12′ are alternately connected in series by the plurality of electrical connectors 24. The term “alternately connected in series” can indicate connecting in sequence as battery cell 12—battery cell 12′—battery cell 12—battery cell 12′, and so on. While some of examples of this disclosure are described in connection with the plurality battery cells 12, 12′, the examples could be used in connection with the plurality of battery cells 14, 14′.

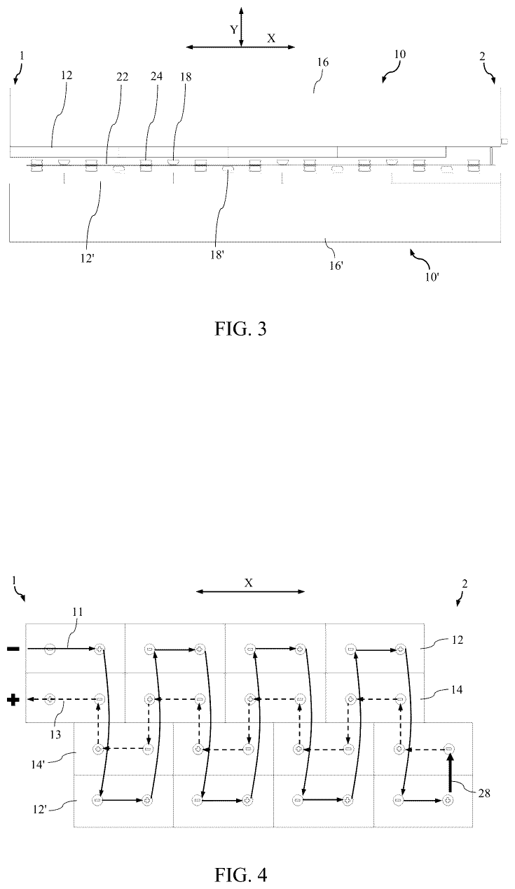

Further referring to FIGS. 2 and 3, electrodes are disposed on the opposite surfaces of the plurality of battery cells 12 and plurality of battery cells 12′, so that electrical connection between the electrodes can be established through the circuit board 20 located between the plurality of battery cells 12, 12′. The plurality of electrical connectors 24 pass through the substrate 22, thereby enabling electrical connection between the electrodes of the battery cells 12, 12′. The electrodes of the plurality of battery cells 12, 12′ are arranged in the same sequence, for example, along the X direction and from a first end 1 to a second end 2 of the battery module 100. The electrode arrangement sequence of each battery cell 12, 12′ is a negative-positive sequence. In embodiments of the present disclosure, for each battery cell, the current is defined to flow from the head-end electrode to the tail-end electrode. In other words, the head-end electrode is negative electrode, and the tail-end electrode is positive electrode. Each of the battery cells 12 is staggered and opposite to a corresponding battery cell 12′, such that a tail-end electrode 12b of the battery cell 12 can be directly opposite (e.g., in a Y direction) to a head-end electrode 12′a of the battery cell 12′. The electrical connector 24 can directly connect the tail-end electrode 12b and head-end electrode 12′a to allow current flow from the head-end electrode 12a to the tail-end electrode 12b of the battery cell 12, from the tail-end electrode 12b to the head-end electrode 12′a of the battery cell 12′, and then to the tail-end electrode 12′b of the battery cell 12′. Similarly, the tail-end electrode 12′b of the battery cell 12′ is opposite to the head-end electrode 12a of the adjacent battery cell 12 and connected by a corresponding electrical connector 24 to allow current flow from the tail-end electrode 12′b of the battery cell 12′ to the head-end electrode 12a of the next battery cell 12, and then to the tail-end electrode 12b of the adjacent battery cell 12. This process is repeated, establishing the alternate connection in series of the plurality of battery cells 12, 12′, forming a current path 11 indicated by multiple solid arrows shown in FIG. 4.

As described above, in the embodiment of the present disclosure, the two battery blocks 10, 10′ are arranged in pairs and share a common circuit board 20. Compared to the prior art where one circuit board is configured for each battery block/battery array, the structure of the present disclosure can reduce the use of circuit boards, thereby saving costs and improving design efficiency. Moreover, since each battery module 100 includes two battery blocks 10, 10′, when performing related battery status detection, there is no need to set separate sampling lines for the two battery blocks. Instead, a unified sampling line can be set for the battery module 100, thus reducing the use of sampling lines. Furthermore, in the embodiment described above, the corresponding electrodes of the plurality of battery cells 12, 12′ are aligned in the Y-direction, allowing direct connection through the plurality of electrical connectors 24 that pass through the substrate 22. This can replace the potentially intricate busbars arranged on the surface of the substrate 22, thereby reducing the number of busbars and materials that are needed. It can be understood that the electrical connectors 24 pass through the substrate 22 and have a relatively short length (e.g., equal to or slightly longer than the thickness of the substrate 22), which can significantly reduce material usage compared to longer busbars extending along the surface of the substrate 22. Additionally, arranging the two battery blocks 10, 10′ in an opposite configuration can also help cover the internal structure of the battery module 100 (such as parts of battery plates and heat conduction channels described further below), and thus provide better visual effects.

In an embodiment, the length of the battery module is flexible, allowing for the addition of new battery cells 12, 12′ to increase its length or the removal of battery cells 12, 12′ to decrease its length, thus making it well-suited for vehicles of different sizes (see, e.g., FIG. 8).

In an embodiment, the battery blocks 10, 10′ include a single layer of battery cells 12, 12′. A first current path 11 flows from the first end 1 to the second end 2 of the battery module 100. By providing corresponding busbars, the current can be further directed from the second end 2 to the first end 1, allowing the main positive and negative terminals of the battery module 100 to be formed at the first end 1 in a simple way.

In some embodiments, the battery block 10 can include two layers of battery cells stacked along a Z direction, with a first layer including multiple battery cells 12 and a second layer including multiple battery cells 14. Similarly, the battery block 10′ can also include two layers of battery cells stacked along the Z direction, with a first layer including multiple battery cells 12′ and a second layer including multiple battery cells 14′. Correspondingly, the circuit board 20 is provided with two rows of electrical connectors arranged along the Z direction, a first row including a plurality of electrical connectors 24, and a second row including a plurality of electrical connectors 26. The battery cells of the first layer of battery block 10 and the battery cells of the first layer of battery block 10′ are alternately connected in series through the first row of electrical connectors 24, forming a first current path 11. Specifically, each of the battery cells 12 in the first layer is staggered and opposite to the corresponding battery cell 12′ in the first layer, with the tail-end electrodes 12b (or 12′b) of the battery cell 12 (or 12′) aligned with the head-end electrodes 12′a (or 12a) of the battery cell 12′ (or 12), and the tail-end electrodes 12b (or 12′b) of the battery cell 12 (or 12′) connected to the head-end electrodes 12′a (or 12a) of the battery cell 12′ (or 12) via the electrical connectors 24. Similarly, the battery cells of the second layer of battery block 10 and the battery cells of the second layer of battery block 10′ are alternately connected in series through the second row of electrical connectors 26, forming a second current path 13. Specifically, each of the battery cells 14 in the second layer is staggered and opposite to the corresponding battery cell 14′ in the second layer, with tail-end electrodes 14b (or 14′b) of the battery cell 14 (or 14′) aligned with head-end electrodes 14′a (or 14a) of the battery cell 14′ (or 14), and the tail-end electrodes 14b (or 14′b) of the battery cell 14 (or 14′) connected to the head-end electrodes 14′a (or 14a) of the battery cell 14′ (or 14) via the electrical connectors 26. The circuit board 20 is also provided with a busbar 28 that connects the first current path 11 and the second current path 13 in series.

As shown in FIG. 4, a flow direction of the first current path 11 is from the first end 1 of the battery module 100 to the second end 2 of the battery module 100, and a flow direction of the second current path 13 is from the second end 2 to the first end 1. The busbar 28 connects the first current path 11 and the second current path 13 at the second end 2. For the two layers of battery cells 12, 12′, 14, 14′ in each battery block 10, 10′, the electrode arrangement sequences are opposite. Thus, the flow directions of the first current path 11 and the second current path 13 are opposite, for instance, along the X direction and from the first end 1 to the second end 2 of the battery module 100. The electrode arrangement sequence of the plurality of battery cells 12 in the first layer of the battery block 10 is negative-positive (i.e., the overall electrode arrangement sequence of the first layer is negative-positive-negative-positive), whereas the electrode arrangement sequence of the plurality of battery cells 14 in the second layer of the battery block 10 is positive-negative (i.e., the overall electrode arrangement sequence of the second layer is positive-negative-positive-negative).

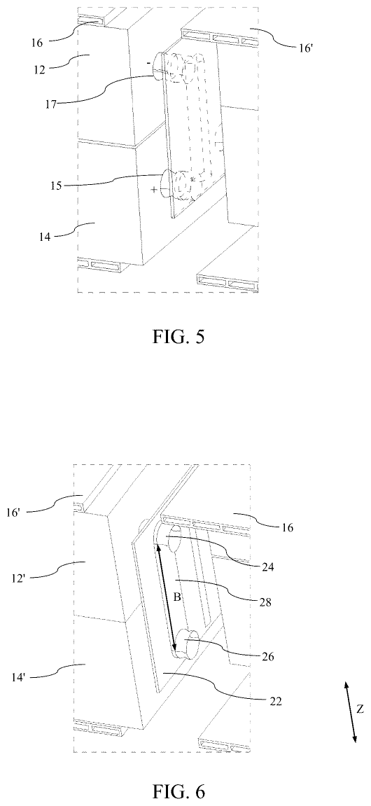

As described above, by arranging two layers of battery cells and two rows of electrical connectors, more battery cells can be contained into a single battery module. The battery cells can share a common circuit board, which reduces the use of circuit boards and sampling lines. Furthermore, in the two-layer arrangement of battery cells, the current flow directions of the first current path 11 and the second current path 13 can be opposite, enabling the placement of the busbar 28 at the second end 2 to connect the first current path 11 and the second current path 13. Current can flow from the first end 1 to the second end 2 and then back to the first end 1, thereby forming the main positive terminal and main negative terminal of the battery module 100 at the first end 1 (as shown in FIG. 5, the positive and negative terminals at the first end 1 constitute a main positive terminal 15 and a main negative terminal 17, respectively). Meanwhile, since the busbar 28 only needs to connect the first current path 11 and the second current path 13 at the second end 2, the busbar 28 can be shortened, further reducing the use of the busbar 28. As shown in FIG. 6, the busbar 28 connects the first row of electrical connectors 24 and the second row of electrical connectors 26 at the second end 2. A length B of the busbar 28 can be a distance between the first row of electrical connectors 24 and the second row of electrical connectors 26 in the Z direction.

In the embodiments of the present disclosure, the circuit board 20 primarily utilizes the substrate 22 as a base to connect the electrical connectors 24, 26, and busbars 28 along the X direction and from the first end 1 to the second end 2 of the battery module 100. The electrical connectors 24, 26, and busbars 28 work together to achieve the electrical connection function of the circuit board 20. The circuit board 20 can adopt any suitable type of circuit board, such as the commonly used flexible printed circuit board (FPCB) in the prior art.

In the embodiments of the present disclosure, directional expressions such as “X direction,” “Y direction,” “Z direction,” etc., are related to the battery module 100 when it is installed on the vehicle. For example, the term “X direction” generally corresponds to the longitudinal (or length) direction of the vehicle in which the battery module is installed, the term “Y direction” generally corresponds to the horizontal (or width) direction of the vehicle, and the term “Z direction” generally corresponds to the height direction of the vehicle.

In some embodiments, the electrical connector 24 is a connecting sleeve with the head-end electrode 12a (or 12′a) and the tail-end electrode 12′b (or 12b) inserted into the sleeve from two ends, respectively. This establishes the electrical connections between the electrical connectors and the electrodes in an efficient and stable way. In another embodiment, the electrodes can also be configured in the form of sleeves, with the electrical connector 24 inserted into these sleeves. Alternatively, the electrical connector 24 and the electrodes can be fixedly connected through methods such as clamping, adhesion, welding, etc. The electrical connector 24 can also take the form of, for example, a sheet or a wire.

Referring to FIG. 2, in some embodiments, a distance A1 between the head-end electrode 12a and the tail-end electrode 12b of the battery cell 12 is half of a dimension A of the battery cell 12 along the X direction. A staggered distance A2 between the battery cell 12 (could also be the battery cell 14, but here the battery cell 12 is used as an example for illustration) and the corresponding battery cell 12′ (could also be the battery cell 14′, but here the battery cell 12′ is used as an example for illustration) is also half of the dimension A of the battery cell 12 along the X direction. The arrangement ensures that the plurality of battery cells 12, 12′ are alternately connected in series, and further ensures that the plurality of battery cells within a respective battery block 10, 10′ are closely arranged (e.g., adjacent battery cells are close to each other with almost no spacing). Accordingly, each battery block 10, 10′ can accommodate as many battery cells as possible, ensuring the compactness and space efficiency of the battery module 100.

In the embodiments of the present disclosure, the distances from the negative and positive electrodes to the same end of the battery cell are respectively ¼ and ¾ of the dimension A of the battery cell along the X direction. This arrangement ensures that the negative and positive electrodes are symmetrically positioned relative to the centerline of the battery cell along the Y direction. By rotating the battery cell 180 degrees around the centerline, a battery cell with an opposite electrode arrangement sequence can be obtained. The battery cells in the first and second layers of battery cells in a double-layer structure can adopt the orientations before and after rotation, respectively. Therefore, the need for two different kinds of battery cells for the double-layer structure is eliminated.

In the embodiments of the present disclosure, when the battery cells are rotated 180 degrees around the centerline along the X direction, the opposite battery cells with the same electrode arrangement sequence can be obtained. The battery cells before and after rotation can serve as the battery cells for two opposing battery blocks, respectively. In some embodiments, the negative and positive electrodes are positioned at the middle of the battery cell in the Z direction, allowing the negative and positive electrodes before and after rotation to align with each other at the same height.

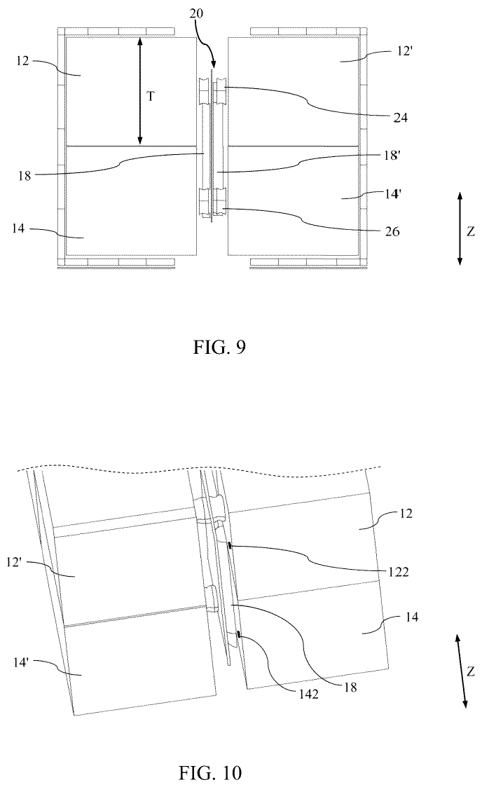

In some embodiments, the battery cells are placed flat. Referring to FIGS. 1 and 9, term “placed flat” can indicate that when the battery module 100 is installed on the vehicle, a thickness dimension T of the battery cells is parallel to the Z direction (the height direction of the vehicle). The battery cells are typically flat, with their thickness being smaller than their length and width. By placing them flat, the size of the battery module 100 along the Z direction can be reduced, enabling a thin battery module design that helps save space in the height direction of the vehicle. The length direction L, width direction W, and thickness direction T of the battery cell 12 can be parallel to the X direction, Y direction, and Z direction, respectively.

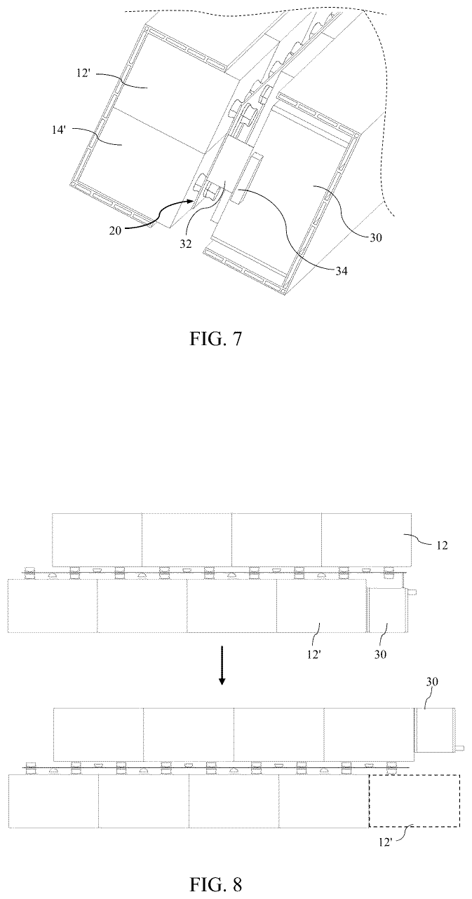

Referring again to FIG. 1, the battery block 10 includes a U-shaped housing 16 that accommodates the battery cells 12, 14, and the battery block 10′ includes a U-shaped housing 16′ that accommodates the battery cells 12′, 14′. The openings of the U-shaped housings 16 and 16′ are opposite each other. The U-shaped housings 16 and 16′ enable the modular design (grouping multiple battery cells together) of the battery blocks 10, 10′ while also protecting the multiple battery cells. As shown in FIG. 1 and FIGS. 5 to 7, the U-shaped housings 16, 16′ have a hollow structure (with multiple cavities formed inside the housing walls), which is conducive to achieving a lightweight design.

Referring to FIGS. 1 to 3 and FIG. 7, the ends of the U-shaped housing 16 and the U-shaped housing 16′ are aligned. Due to the staggered arrangement of the battery block 10 and the battery block 10′, a void portion 162 is formed at one end of the U-shaped housing 16. The battery module 100 further includes a battery control module 30 disposed in the void portion 162 and electrically connected to the circuit board 20. By positioning the battery control module 30 in the void portion 162, the space within the U-shaped housing 16 is fully utilized, enabling a compact design for the battery module 100. The battery control module 30 can be an assistant battery control module (e.g., an assistant BECM or Battery Energy Control Module), with its input end 32 electrically connected to the circuit board 20 and its output end 34 connected to the main battery control module (e.g., main BECM or Battery Energy Control Module).

Referring to FIGS. 3 and 10, the battery block 10 can further include multiple heat conduction channels 18 arranged along the X direction. Each heat conduction channel 18 extends along the Z direction and communicates with the ventilation portions 122, 142 of two stacked battery cells 12, 14. In other words, two battery cells share one heat conduction channel. Similarly, the battery block 10′ also can include multiple heat conduction channels 18′ arranged along the X direction, with each heat conduction channel 18′ extending along the Z direction and communicating with the ventilation portions of two stacked battery cells 12′, 14′. When the battery module 100 is installed on a vehicle, the heat conduction channels 18 can guide gas and/or heat generated by the battery cells downwards towards the bottom of the battery module to minimize heat transfer. The heat conduction channels 18 can have an arcuate cross-section. The heat conduction channels 18 are disposed between the circuit board 20 and the battery blocks 10, 10′.

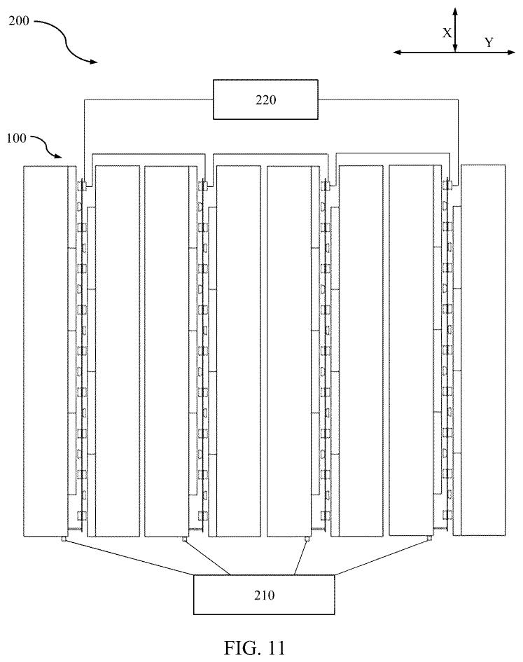

FIG. 11 illustrates a battery pack 200, including: a battery pack housing; and one or more battery modules 100 as described in the above embodiments disposed within the battery pack housing. The multiple battery modules 100 can be arranged along the Y direction. In some embodiments, the battery pack 200 further includes a main battery control module 210 electrically connected to the assistant battery control modules of the multiple battery modules 100. In some embodiments, the battery pack 200 further includes a BEC circuit (Battery Eliminator Circuit) 220 electrically connected to the multiple battery modules 100. As described above, by configuring each battery module to include two battery blocks opposite each other and each battery block including two layers of battery cells, more battery cells can be combined into one battery module. This can reduce the number of battery modules and thus the number of related electrical connection components required to connect the battery modules to the main battery control module 210 or the BEC circuit 220.

The present disclosure further provides a vehicle that includes the battery pack 200 as described in the above embodiments.

In summary, the configurations of the present disclosure enables two battery blocks to share one circuit board, thereby saving costs and improving design efficiency. The electrical connectors that pass through the substrate of the circuit board can partially replace the busbars, and only one end of the double-layer battery cell is connected with a shorter busbar to form two current paths, thereby achieving a design with fewer busbars and saving materials. By configuring the battery cells to lie flat, the total height of the battery module is mainly determined by the thickness of the battery cells, which saves space in the height direction of the vehicle. The length of the battery block is flexible, and the length of the battery block can be adjusted by adding or removing battery cells so as to adapt to different sizes of vehicles. The exhaust gas from the battery cells can be guided to the bottom of the battery module through the heat conduction channel.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only illustrative, and is not intended to imply that the disclosed scope of the embodiments of the present disclosure (including claims) is limited to these examples; and under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

What is claimed is:

1. A battery module, comprising:
a first battery block and a second battery block that is opposite the first battery block, wherein the first battery block includes a first plurality of battery cells, the second battery block includes a second plurality of battery cells, and the first plurality of battery cells and the second plurality of battery cells are arranged along a first direction; and
a circuit board disposed between the first and second battery blocks,
wherein the first plurality of battery cells and the second plurality of battery cells are staggered along the first direction.

2. The battery module of claim 1, wherein each battery cell of the first plurality of battery cells and the second plurality of battery cells has a length, and the battery cells of the first plurality battery cells are staggered relative to the battery cells of the second plurality of battery cells by half of the length.

3. The battery module of claim 2, wherein adjacent battery cells of the first plurality of battery cells interface at a midline of a battery cell of the second plurality of battery cells that is opposite the adjacent battery cells of the first plurality of battery cells.

4. The battery module of claim 1, wherein further comprising a plurality of electrical connectors that pass through the circuit board, the plurality of electrical connectors configured to alternately connect the first plurality of battery cells to the second plurality of battery cells in series.

5. The battery module of claim 4, wherein each battery cell of the first plurality of battery cells and the second plurality of battery cells includes a head-end electrode and a tail-end electrode.

6. The battery module of claim 5, wherein the head-end electrode and the tail-end electrode of each battery cell is oppositely charged.

7. The battery module of claim 6, wherein through the plurality of electrical connectors, the head-end electrodes of the first plurality of battery cells are connected to the tail-end electrodes of the second plurality of battery cells, and the tail-end electrodes of the first plurality of battery cells are connected to the head-end electrodes of the second plurality of battery cells.

8. The battery module of claim 6, wherein the head-end electrodes of the first plurality of battery cells and the tail-end electrodes of the second plurality of battery cells are oppositely charged, and the tail-end electrodes of the first plurality of battery cells and the head-end electrodes of the second plurality of battery cells are oppositely charged.

9. The battery module of claim 1, further comprising a first housing that at least partially houses the first battery block and a second housing that at least partially houses the second battery block.

10. The battery module of claim 1, further comprising a battery control module disposed adjacent to a battery cell of one of the first plurality of battery cells and the second plurality of battery cells.

11. The battery module of claim 1, further comprising a first plurality of heat conduction channels disposed between the first plurality of battery cells and the circuit board and a second plurality of heat conduction channels disposed between the second plurality of battery cells and the circuit board.

12. A battery module, comprising:
a first battery block and a second battery block opposite the first battery block, the first battery block and the second battery block each include a first layer of battery cells and a second layer of battery cells stacked along a first direction;
a circuit board disposed between the first and second battery blocks;
a first plurality of electrical connectors and an opposite second plurality of electrical connectors, wherein the first plurality of electrical connectors and the second plurality of connectors each pass through the circuit board; and
a busbar configured to connect the first plurality of electrical connectors to the second plurality of electrical connectors.

13. The battery module of claim 12, wherein the first plurality of electrical connectors is vertically above the second plurality of electrical connectors.

14. The battery module of claim 13, wherein the first plurality of electrical connectors forms a first current path between the first layer of battery cells of the first battery block and the first layer of battery cells of the second battery block, and the second plurality of electrical connectors forms a second current path between the second layer of battery cells of the first battery block and the second layer of battery cells of the second battery block.

15. The battery module of claim 14, wherein the busbar connects the first current path to the second current path in series.

16. The battery module of claim 12, wherein the first and second layers of battery cells of the first battery block are staggered relative to the first and second layers of battery cells of the second battery block.

17. The battery module of claim 12, wherein each battery cell of the first battery block and the second battery block includes a head-end electrode and an oppositely charged tail-end electrode.

18. The battery module of claim 12, wherein the first layer of battery cells of the first battery block and the first layer of battery cells of the second battery block are alternately connected in series through the first plurality of electrical connectors, and the second layer of battery cells of the first battery block and the second layer of battery cells of the second battery block are alternately connected in series through the second plurality of electrical connectors.

19. The battery module of claim 12, wherein the busbar includes an input end that is connected to the circuit board and an output end that is connected to a battery control module.

20. The battery module of claim 19, wherein the battery control module is disposed at an end of one of the first and second battery blocks.
